(19) United States
(12) Patent Application Publication
(10) Pub. No.: US 2009/0019885 A1
(43) Pub. Date: Jan. 22, 2009

(54) Evaporator

(75) Inventors: Ryoichi Hoshino, Oyama-shi (JP); Yasuhiro Takahashi, Oyama-shi (JP); Hiroki Shibata, Oyama-shi (JP)

Correspondence Address: EDWARDS ANGELL PALMER & DODGE LLP, P.O. BOX 55874, BOSTON, MA, 02205, US

(73) Assignee: SHOWA DENKO K.K., Tokyo (JP)

(21) Appl. No.: 12/216,184

(22) Filed: Jul. 1, 2008

(30) Foreign Application Priority Data
Jul. 17, 2007 (JP) 2007-185955

(51) Int. Cl. F25B 39/02; B60H 1/00; F28F 3/12; F28F 1/10

(52) U.S. Cl. 62/515; 165/41; 165/168; 165/181

(57) ABSTRACT

An evaporator includes a refrigerant flow section which is provided on the refrigerant outlet header section. Refrigerant fed from a condenser and not yet having passed through a pressure-reducing device flows through the refrigerant flow section. The refrigerant flow section is composed of a refrigerant flow pipe brazed to the outer surface of the refrigerant outlet header section. Heat exchange is effected between the refrigerant within the refrigerant outlet header section and the refrigerant flowing through the refrigerant flow section. This evaporator eliminates the necessity of adding extra components to a refrigeration cycle, reduces the installation space and cost of the refrigeration cycle, and improves the cooling performance thereof.

### BACKGROUND OF THE INVENTION

The present invention relates to an evaporator, and more particularly to an evaporator preferably used in a car air conditioner, which is a refrigeration cycle to be mounted on, for example, an automobile.

Herein and in the appended claims, the downstream side (a direction represented by arrow X in FIG. 1) of an air flow through air-passing clearances between adjacent heat exchange tubes will be referred to as the “front,” and the opposite side as the “rear.” The left-hand and right-hand sides of FIG. 2 will be referred to as “left” and “right,” respectively. Further, herein and in the appended claims, the term “aluminum” encompasses aluminum alloys in addition to pure aluminum. Moreover, herein and in the appended claims, the term “condenser” encompasses not only ordinary condensers, but also sub-cool condensers including a condensing section and a supercooling section.

Conventionally, a refrigeration cycle which includes a compressor, a condenser, an evaporator, an expansion valve serving as a pressure-reducing device, and a gas-liquid separator has been widely used in a car air conditioner (hereinafter, this refrigeration cycle will be referred to as a “conventional-type refrigeration cycle”).

Incidentally, in order to further improve the cooling performance of a refrigeration cycle; i.e., the cooling performance of the evaporator thereof, there has been proposed a refrigeration cycle which comprises a compressor; a condenser including a condensing section and a supercooling section; an evaporator; an expansion valve serving as a pressure-reducing device; a gas-liquid separator; and an intermediate heat exchanger disposed between the condenser and the evaporator and effecting heat exchange between high-pressure refrigerant flowing out of the supercooling section of the condenser and low-pressure refrigerant flowing out of the evaporator (see Japanese Patent Application Laid-Open (kokai) No. 2006-132905). The refrigeration cycle disclosed in the patent publication is designed such that the refrigerant having been supercooled at the supercooling section of the condenser is further cooled at the intermediate heat exchanger by means of the low-temperature, low pressure refrigerant flowing out of the evaporator, whereby the cooling performance of the evaporator is improved.

The intermediate heat exchanger used in the refrigeration cycle disclosed in the above-mentioned patent publication has a double tube structure composed of an inner tube and an outer tube. The interior of the inner tube serves as a first flow path through which the high-pressure refrigerant flowing out of the condenser flows, and the space between the outer tube and the inner tube serves as a second flow path through which the low-pressure refrigerant flowing out of the evaporator flows.

However, the refrigeration cycle disclosed in the above-mentioned patent publication has a problem in that the engine compartment of an automobile needs an extra space for disposing an intermediate heat exchanger composed of inner and outer tubes. In addition, the refrigeration cycle has a problem in that the number of components increases, resulting in an increase in cost, as compared with the conventional-type refrigeration cycle which includes a compressor, a condenser, an evaporator, an expansion valve serving as a pressure-reducing device, and a gas-liquid separator.

### SUMMARY OF THE INVENTION

An object of the present invention is to solve the above problem and to provide an evaporator which eliminates the necessity of an extra space for disposing an intermediate heat exchanger when a refrigeration cycle is installed in an automobile, which can reduce cost of the refrigeration cycle, and which has improved cooling performance as compared with the evaporator of the conventional-type refrigeration cycle.

To achieve the above object, the present invention comprises the following modes.

1) An evaporator comprising a refrigerant inlet header section extending in a left-right direction, a refrigerant outlet header section extending in the left-right direction, and a refrigerant passageway which establishes communication between the refrigerant inlet header section and the refrigerant outlet header section, wherein a refrigerant inlet is formed in the refrigerant inlet header section; a refrigerant outlet is formed in the refrigerant outlet header section; and refrigerant having flowed into the interior of the refrigerant inlet header section from the refrigerant inlet flows into the interior of the refrigerant outlet header section via the refrigerant passageway and is fed out from the refrigerant outlet, wherein
a refrigerant flow section is provided on the refrigerant outlet header section so as to allow refrigerant fed from a condenser and not yet having passed through a pressure-reducing device to flow through the refrigerant flow section, such that heat exchange is effected between the refrigerant within the refrigerant outlet header section and the refrigerant flowing through the refrigerant flow section.

2) An evaporator according to par. 1), wherein the refrigerant flow section is composed of a refrigerant flow pipe which is mechanically or metallurgically joined to a wall surface of the refrigerant outlet header section.

3) An evaporator according to par. 2), wherein a pipe-holding portion is provided on the wall surface of the refrigerant outlet header section, and the refrigerant flow pipe is held by the pipe-holding portion.

4) An evaporator according to par. 3), wherein the refrigerant flow pipe has a generally circular transverse cross section, and the pipe-holding portion is shaped such that the pipe-holding portion comes into contact with an outer circumferential surface of the refrigerant flow pipe.

5) An evaporator according to par. 4), wherein the refrigerant outlet header section is formed of a plurality of members, at least one of the members is formed of an extrudate, and the pipe-holding portion is integrally formed on the member formed of an extrudate.

6) An evaporator according to par. 2), wherein the refrigerant outlet header section has a flat surface formed on its outer surface and extending in a longitudinal direction of the refrigerant outlet header section, the refrigerant flow pipe assumes a flat shape and has a pair of flat walls, and an outer surface of one of the flat walls of the refrigerant flow pipe is in surface contact with the flat surface on the outer surface of the refrigerant outlet header section.

7) An evaporator according to par. 2), wherein the refrigerant outlet header section has an inner fin formed on its inner surface and extending in a longitudinal direction of the refrigerant outlet header section.

8) An evaporator according to par. 1), wherein the refrigerant outlet header section is formed of a plurality of members, at least one of the members is formed of an extrudate, and the member formed of an extrudate has an integrally formed hollow refrigerant flow section extending in a longitudinal direction of the member formed of an extrudate.

9) An evaporator according to par. 8), wherein the refrigerant flow section is formed on the outer side of the refrigerant outlet header section.

10) An evaporator according to par. 9), wherein the refrigerant outlet header section has an inner fin formed on its inner surface and extending in a longitudinal direction of the refrigerant outlet header section.

11) An evaporator according to par. 8), wherein the refrigerant flow section is formed on the inner side of the refrigerant outlet header section.

12) An evaporator according to par. 11), wherein the refrigerant flow section has an inner fin formed on its surface facing the interior of the refrigerant outlet header section such that the inner fin extends in a longitudinal direction of the refrigerant flow section.

13) An evaporator according to par. 1), wherein the refrigerant inlet header section and the refrigerant outlet header section are disposed side by side in a front-rear direction; and the refrigerant passageway includes a first intermediate header section extending in the left-right direction and separated from the refrigerant inlet header section, a second intermediate header section extending in the left-right direction, disposed on the rear side of the first intermediate header section to be separated from the refrigerant outlet header section, and communicating with the first intermediate header section, a plurality of heat exchange tubes disposed between the refrigerant inlet header section and the first intermediate header section and having opposite ends connected to the refrigerant inlet header section and the first intermediate header section, and a plurality of heat exchange tubes disposed between the refrigerant outlet header section and the second intermediate header section and having opposite ends connected to the refrigerant outlet header section and the second intermediate header section.

14) An evaporator according to par. 13), wherein the refrigerant inlet header section and the refrigerant outlet header section are integrated together to form a refrigerant inlet/outlet header tank, and the refrigerant inlet/outlet header tank includes a first member which is formed of aluminum and to which the heat exchange tubes are connected, and a second member which is joined to a side of the first member opposite the heat exchange tubes and which is formed of an aluminum extrudate.

The evaporators of pars. 1) and 2) each constitute a refrigeration cycle in cooperation with a compressor, a condenser, an expansion valve serving as a pressure-reducing device, and a gas-liquid separator. In such a refrigeration cycle, liquid-phase refrigerant of relatively high temperature and pressure, having been compressed by the compressor and passed through the condenser, is caused to flow through the refrigerant flow section and is fed to the expansion valve, at which the pressure of the refrigerant is reduced. Subsequently, the refrigerant flows into the refrigerant inlet header section of the evaporator, passes through the refrigerant passageway, and enters the refrigerant outlet header section. While flowing through the refrigerant passageway, the refrigerant exchanges heat with air flowing through air-passing clearances, so that the temperature of the refrigerant is lowered. The refrigerant having been lowered in temperature flows into the refrigerant outlet header section. Heat exchange is effected between the refrigerant which flows through the refrigerant flow section and which is high in temperature and pressure and the refrigerant which is located within the refrigerant outlet header section and which is low in temperature and pressure, so that the refrigerant flowing through the refrigerant flow section is cooled. Therefore, the temperature of the refrigerant which flows into the refrigerant inlet header section via the expansion valve is lowered, and thus, the cooling performance of the evaporator is improved.

That is, according to the evaporators of pars. 1) and 2), the refrigerant outlet header section and the refrigerant flow section function as an intermediate heat exchanger disclosed in the above-mentioned patent publication. Therefore, separate provision of an intermediate heat exchanger is not required. Accordingly, when a refrigeration cycle is installed in an automobile, an extra space is not needed, and cost of the refrigeration cycle can be lowered. In addition, the evaporator has improved cooling performance as compared with the conventional-type refrigeration cycle which does not utilize an intermediate heat exchanger.

According to the evaporators of pars. 3) to 6), the area of contact between the outer surface of the refrigerant outlet header section and the refrigerant flow pipe increases, resulting in an increase in the efficiency of heat exchange between the high temperature, high pressure refrigerant flowing through the refrigerant flow section and the low temperature, low pressure refrigerant within the refrigerant outlet header section.

According to the evaporator of par. 5), the pipe-holding portion can be formed in a relatively simple manner.

According to the evaporator of par. 7), the heat transmission area of the inner surface of the refrigerant outlet header section increases, resulting in an increase in the efficiency of heat exchange between the high temperature, high pressure refrigerant flowing through the refrigerant flow section and the low temperature, low pressure refrigerant within the refrigerant outlet header section.

According to the evaporators of pars. 8), 9), and 11), the refrigerant outlet header section is formed of a plurality of members, at least one of the members is formed of an extrudate, and the member formed of an extrudate has an integrally formed hollow refrigerant flow section extending in a longitudinal direction thereof. This structure enables the refrigerant flow section to be formed in a relatively simple manner, and increases the efficiency of heat exchange between the high temperature, high pressure refrigerant flowing through the refrigerant flow section and the low temperature, low pressure refrigerant within the refrigerant outlet header section.

According to the evaporator of par. 10), the heat transmission area of the inner surface of the refrigerant outlet header section increases, resulting in an increase in the efficiency of heat exchange between the high temperature, high pressure refrigerant flowing through the refrigerant flow section and the low temperature, low pressure refrigerant within the refrigerant outlet header section.

According to the evaporator of par. 12), the heat transmission area of the inner surface of the refrigerant flow section increases, resulting in an increase in the efficient of heat exchange between the high temperature, high pressure refrigerant flowing through the refrigerant flow section and the low temperature, low pressure refrigerant within the refrigerant outlet header section.

### BRIEF DESCRIPTION OF THE DRAWINGS

FIG. 1 is a partially cut-away perspective view showing the overall configuration of an evaporator according to the present invention;

FIG. 2 is a vertical cross sectional view of the evaporator of FIG. 1 as it is seen from the rear, with its intermediate portion omitted;

FIG. 3 is a partially-omitted, enlarged cross sectional view taken along line A-A of FIG. 2;

FIG. 4 is an exploded perspective view of a refrigerant inlet/outlet header tank of the evaporator;

FIG. 5 is a cross sectional view taken along line B-B of FIG. 2;

FIG. 6 is an exploded perspective view showing a joint plate and a right end portion of a refrigerant turn header tank of the evaporator;

FIG. 7 is a partially cut-away cross sectional view taken along line C-C of FIG. 2;

FIG. 8 is a schematic diagram showing a refrigeration cycle which uses the evaporator of FIG. 1;

FIG. 9 is a Mollier diagram of the refrigeration cycle which uses the evaporator of FIG. 1;

FIG. 10 is a view corresponding to a portion of FIG. 3 and showing a first modification of a refrigerant flow section provided on a refrigerant outlet header section;

FIG. 11 is a view corresponding to a portion of FIG. 3 and showing a second modification of the refrigerant flow section provided on the refrigerant outlet header section;

FIG. 12 is a view corresponding to a portion of FIG. 3 and showing a third modification of the refrigerant flow section provided on the refrigerant outlet header section; and

FIG. 13 is a view corresponding to a portion of FIG. 3 and showing a fourth modification of the refrigerant flow section provided on the refrigerant outlet header section.

### DESCRIPTION OF THE PREFERRED EMBODIMENT

A preferred embodiment of the present invention will next be described with reference to the drawings.

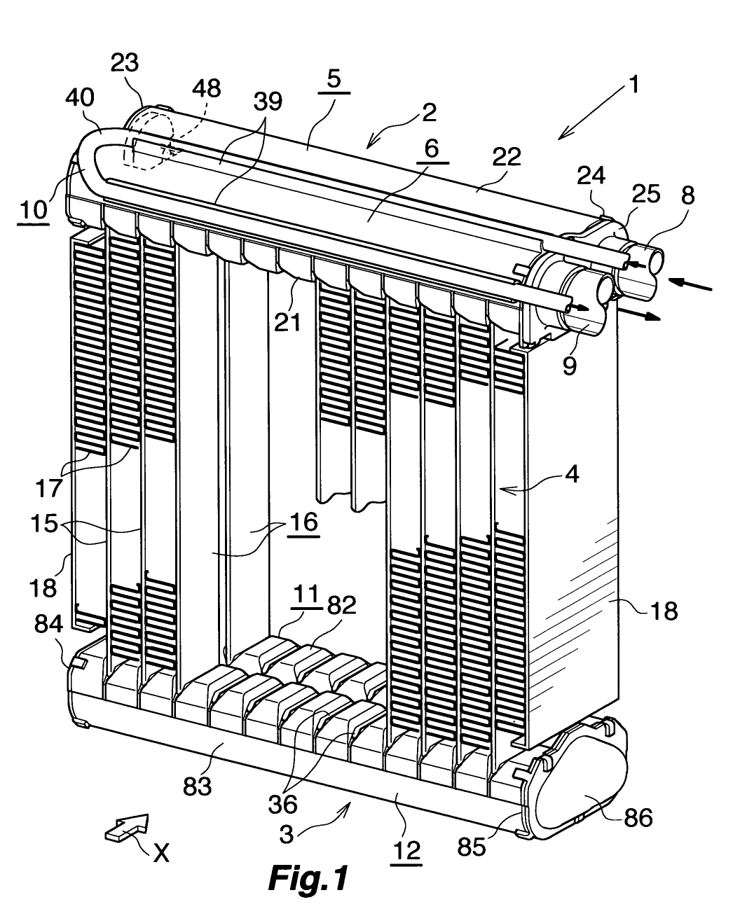

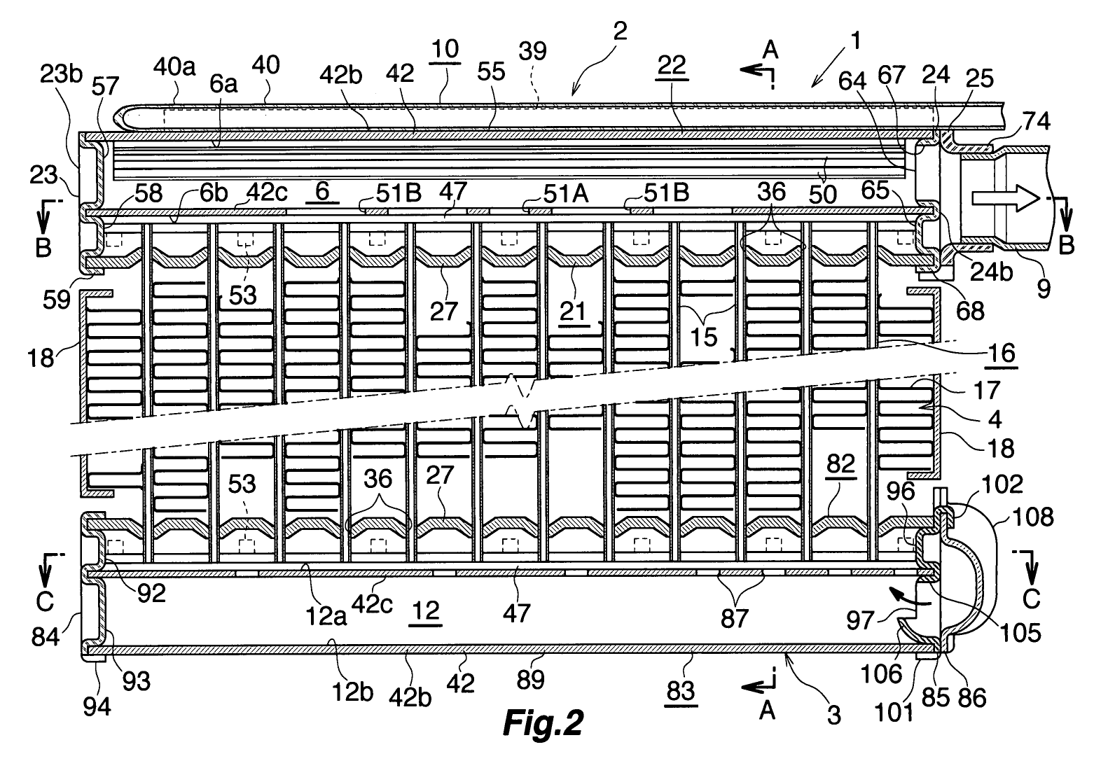

In the following description, the upper and lower sides of FIGS. 1 and 2 will be referred to as “upper” and “lower,” respectively. Further, the same reference numerals are used throughout the drawings to refer to the same portions and members, and their repeated descriptions are omitted.

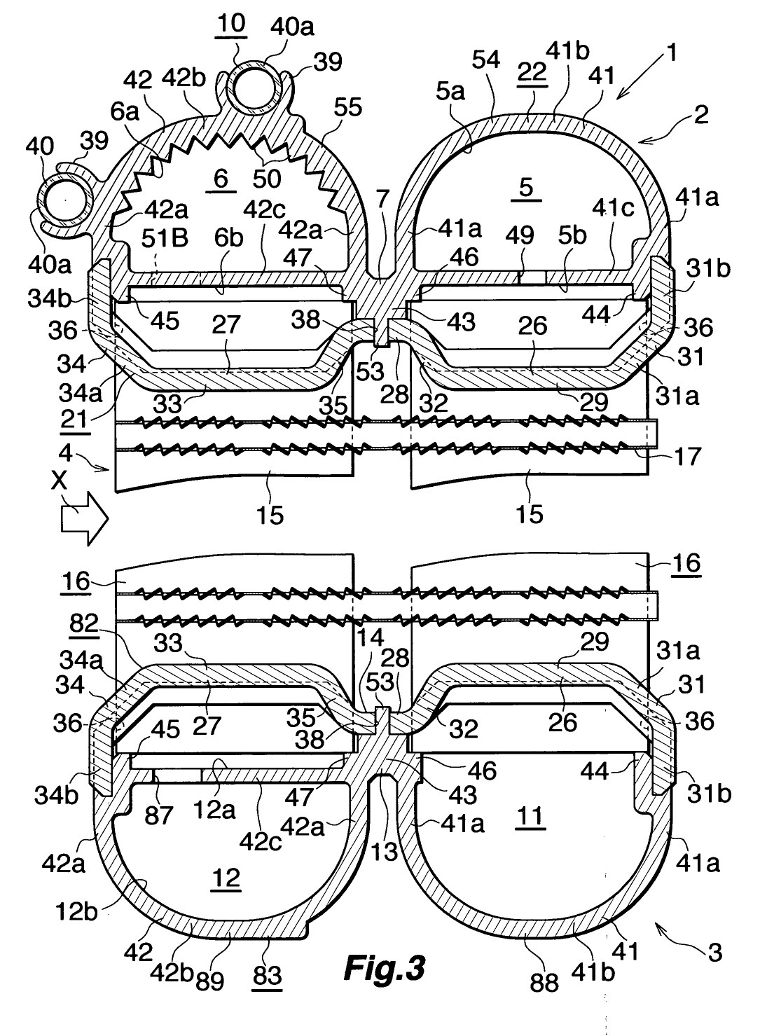

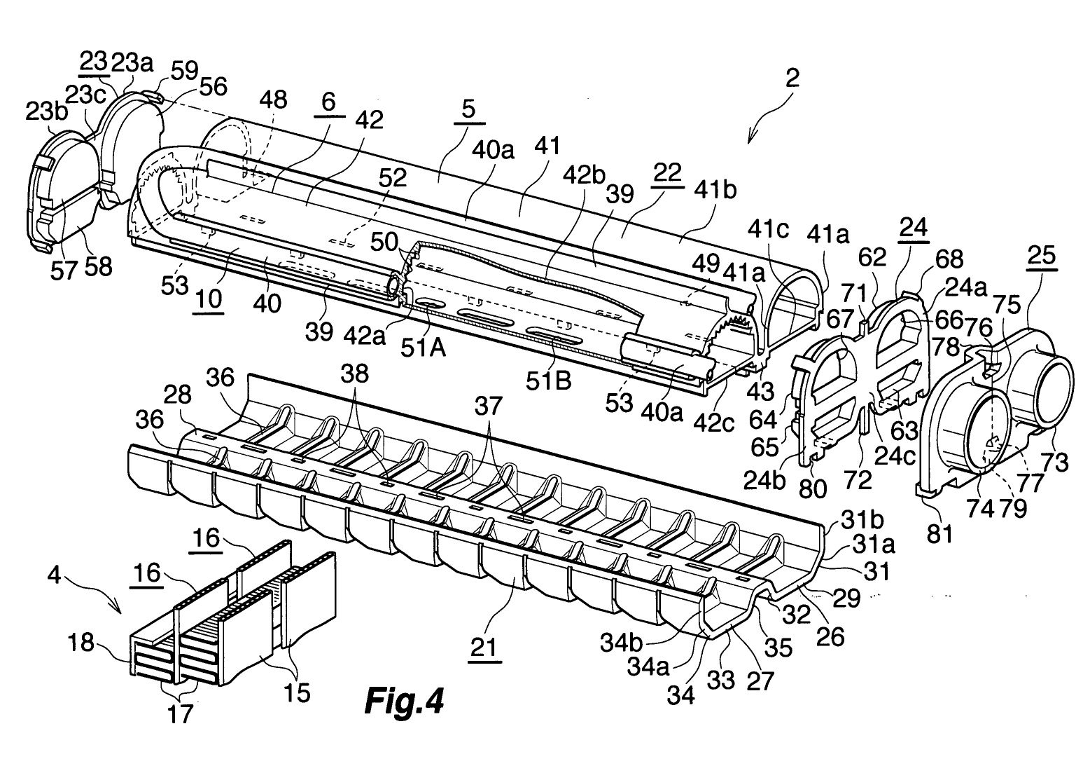

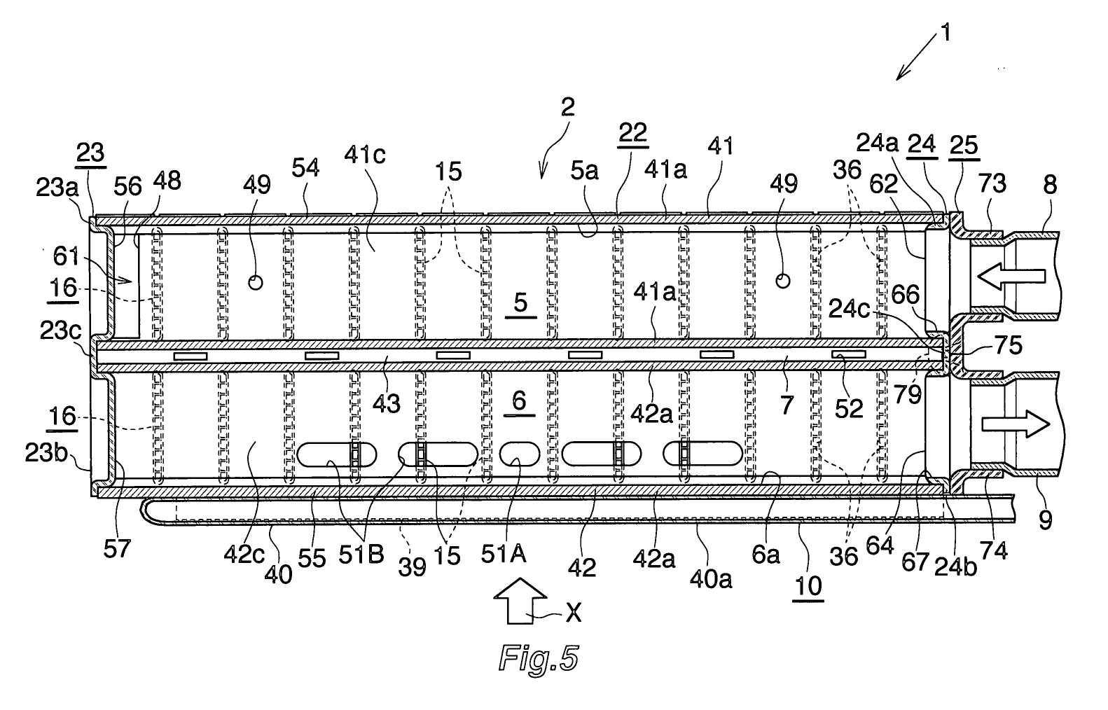

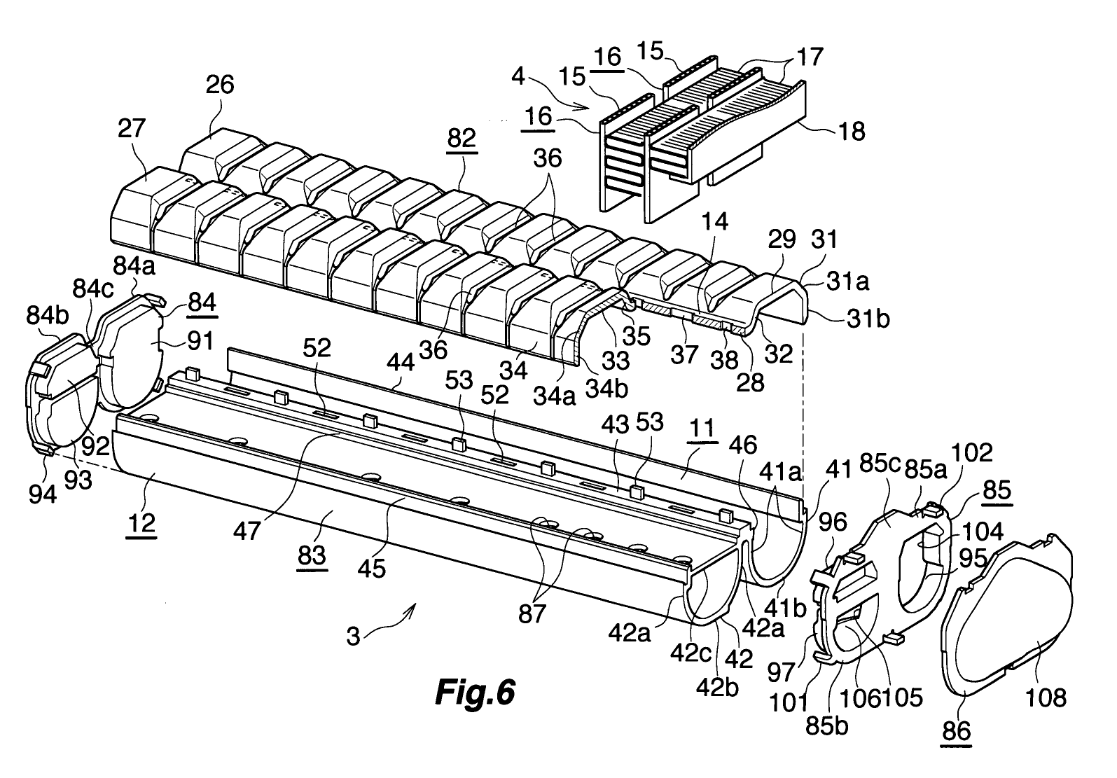

FIGS. 1 and 2 show the overall configuration of an evaporator, and FIGS. 3 to 7 show the configuration of a main portion of the evaporator.

As shown in FIGS. 1 to 3, the evaporator (1) is configured such that a heat exchange core section (4) is provided between a refrigerant inlet/outlet header tank (2) made of aluminum and a refrigerant turn header tank (3) made of aluminum, which are separated from each other in the vertical direction.

The refrigerant inlet/outlet header tank (2) includes a refrigerant inlet header section (5) located on the front side (downstream side with respect to the air flow direction); a refrigerant outlet header section (6) located on the rear side (upstream side with respect to the air flow direction); and a connection portion (7) for mutually connecting the header sections (5) and (6) for integration. A refrigerant flow section (10) is provided on the refrigerant outlet header section (6) so as to allow refrigerant fed from a condenser and not yet having passed through an expansion valve (a pressure-reducing device) to flow through the refrigerant flow section (10), so that heat exchange is effected between refrigerant within the refrigerant outlet header section (6) and refrigerant flowing through the refrigerant flow section (10). A refrigerant inlet pipe (8) made of aluminum is connected to the refrigerant inlet header section (5) of the refrigerant inlet/outlet header tank (2). A refrigerant outlet pipe (9) made of aluminum is connected to the refrigerant outlet header section (6) of the refrigerant inlet/outlet header tank (2).

The refrigerant turn header tank (3) includes a first intermediate header section (11) located on the front side and facing the refrigerant inlet header section (5); a second intermediate header section (12) located on the rear side and facing the refrigerant outlet header section (6); and a connection portion (13) for mutually connecting the header sections (11) and (12) for integration. The header sections (11) and (12) and the connection portion (13) form a drain trough (14). The circumferential walls of the refrigerant inlet/outlet header tank (2) and the refrigerant turn header tank (3) have transverse cross sectional shapes which are identical with each other but are mirror images with respect to the vertical direction.

The heat exchange core section (4) is configured such that a plurality of (two, in the present embodiment) heat exchange tube groups (16) are arranged side by side in the front-rear direction, each heat exchange tube group (16) consisting of a plurality of heat exchange tubes (15) arranged in parallel at predetermined intervals in the left-right direction. Corrugate fins (17) are disposed within air-passing clearances between the adjacent heat exchange tubes (15) of the heat exchange tube groups (16) and on the outer sides of the leftmost and rightmost heat exchange tubes (15) of the heat exchange tube groups (16), and are brazed to the corresponding heat exchange tubes (15). Side plates (18) made of aluminum are disposed on the outer sides of the leftmost and rightmost corrugate fins (17), and are brazed to the corresponding corrugate fins (17). The upper and lower ends of the heat exchange tubes (15) of the front heat exchange tube group (16) are connected to the refrigerant inlet header section (5) and the first intermediate header section (11), respectively. The upper and lower ends of the heat exchange tubes (15) of the rear heat exchange tube group (16) are connected to the refrigerant outlet header section (6) and the second intermediate header section (12), respectively. The first intermediate header section (11), the second intermediate header section (12), and all the heat exchange tubes (15) constitute a refrigerant passageway that establishes communication between the refrigerant inlet header section (5) and the refrigerant outlet header section (6).

Each of the heat exchange tubes (15) is formed from a bare aluminum extrudate, and assumes a flat form such that its width direction coincides with the front-rear direction. The heat exchange tube (15) has a plurality of refrigerant channels arranged in parallel in the width direction. Each of the corrugated fins (17) is made in a wavy form from an aluminum brazing sheet having a brazing material layer over opposite surfaces thereof. Each of the corrugate fins (17) includes wave crest portions, wave trough portions, and horizontal flat connection portions connecting the wave crest portions and the wave trough portions. A plurality of louvers are formed at the connection portions in such a manner as to be juxtaposed in the front-rear direction. The front and rear heat exchange tubes (15) that constitute the front and rear heat exchange tube groups (16) share the corrugate fins (17). The width of each corrugate fin (17) as measured in the front-rear direction is generally equal to the distance between the front edges of the front heat exchange tubes (15) and the rear edges of the rear heat exchange tubes (15). The wave crest portions and the wave trough portions of the corrugate fins (17) are brazed to the front and rear heat exchange tubes (15). The front edges of the corrugate fins (17) slightly project frontward from the front edges of the front heat exchange tubes (15). Notably, instead of a single corrugate fin being shared between the front and rear heat exchange tube groups (16), a corrugate fin may be disposed between the adjacent heat exchange tubes (15) of each of the front and rear heat exchange tube groups (16).

In the present embodiment, each of the heat exchange tubes (15) is formed of an aluminum extrudate. However, each of the heat exchange tubes (15) may be formed of an aluminum welded tube into which an inner fin is inserted so as to form a plurality of refrigerant channels within the tube. Alternatively, each of heat exchange tubes (15) may fabricated through rolling of an aluminum brazing sheet which has a brazing material layer over each of opposite sides thereof and which includes two flat-wall-forming portions connected via a connection portion, side-wall-forming portions which are integrally formed at side edges of the two flat-wall-forming portions opposite the connection portion, and a plurality of reinforcement-wall-forming portions integrally formed on the flat-wall-forming portions at predetermined intervals in the width direction of the flat-wall-forming portions such that the reinforcement-wall-forming portions project from the flat-wall-forming portions. The sheet is bent at the connection portion into a hairpin-like shape such that the side-wall-forming portions come into engagement with each other. The side-wall-forming portions are brazed together, so that the reinforcement-wall-forming portions form reinforcement walls. In this case, corrugate fins formed of a bare material are used.

As shown in FIGS. 2 to 5, the refrigerant inlet/outlet header tank (2) is composed of a plate-like first member (21), a second member (22), and aluminum left and right end members (23) and (24). The first member (21) is formed through press working from an aluminum brazing sheet having a brazing material layer over opposite surfaces thereof. All the heat exchange tubes (15) are connected to the first member (21). The second member (22) is formed from a bare aluminum extrudate, and covers the upper side of the first member (21). The aluminum end members (23) and (24) are formed through press working from an aluminum brazing sheet having a brazing material layer over opposite surfaces thereof, and are brazed to the left and right ends of the first member (21) and the second member (22). A joint plate (25) made of aluminum and elongated in the front-rear direction is brazed to the outer surface of the right end member (24) while extending over the refrigerant inlet header section (5) and the refrigerant outlet header section (6). The refrigerant inlet pipe (8) and the refrigerant outlet pipe (9) are joined to the joint plate (25). Notably, the joint plate (25) is formed from an aluminum bare material through press working.

The first member (21) includes a first header-forming portion (26) which bulges downward and forms a lower portion of the refrigerant inlet header section (5); a second header-forming portion (27) which bulges downward and forms a lower portion of the refrigerant outlet header section (6); and a connection wall (28) which connects a rear edge portion of the first header-forming portion (26) and a front edge portion of the second header-forming portion (27) and forms a lower portion of the connection portion (7). The first header-forming portion (26) includes a horizontal flat bottom wall (29), and front and rear walls (31) and (32) integrally formed at the front and rear edge portions of the bottom wall (29). The front wall (31) includes a slant portion (31a) extending upward from the front edge of the bottom wall (29) while inclining toward the front side, and a vertical portion (31b) extending upward from the upper edge of the slant portion (31a). The rear wall (32) extends upward from the rear edge of the bottom wall (29) while inclining toward the rear side. The upper end of the front wall (31) is located above that of the rear wall (32). The second header-forming portion (27), which is a mirror image of the first header-forming portion (26) with respect to the front-rear direction, includes a horizontal flat bottom wall (33), and rear and front walls (34) and (35) integrally formed at the rear and front edge portions of the bottom wall (33). The rear wall (34) includes a slant portion (34a) extending upward from the rear edge of the bottom wall (33) while inclining toward the rear side, and a vertical portion (34b) extending upward from the upper edge of the slant portion (34a). The front wall (35) extends upward from the front edge of the bottom wall (33) while inclining toward the front side. The upper end of the rear wall (34) is located above that of the front wall (35). The upper edge of the rear wall (32) of the first header-forming portion (26) and the upper edge of the front wall (35) of the second header-forming portion (27) are integrally connected by the connection wall (28).

A plurality of tube insertion holes (36), which are elongated in the front-rear direction, are formed in the two header-forming portions (26) and (27) of the first member (21) at predetermined intervals in the left-right direction. The tube insertion holes (36) of the first header-forming portion (26) and those of the second header-forming portion (27) are identical in position in the left-right direction. The tube insertion holes (36) of the first header-forming portion (26) are formed to extend from the slant portion (31a) of the front wall (31) to the rear wall (32); and the tube insertion holes (36) of the second header-forming portion (27) are formed to extend from the slant portion (34a) of the rear wall (34) to the front wall (35). Upper end portions of the heat exchange tubes (15) of the front and rear heat exchange tube groups (16) of the heat exchange core section (4) are inserted into the tube insertion holes (36) of the header-forming portions (26) and (27), and are brazed to the first member (21) by making use of the brazing material layer of the first member (21). Thus, the upper end portions of the heat exchange tubes (15) of the front heat exchange tube group (16) are connected to the refrigerant inlet header section (5) such that fluid communication is established therebetween; and the upper end portions of the heat exchange tubes (15) of the rear heat exchange tube group (16) are connected to the refrigerant outlet header section (6) such that fluid communication is established therebetween. A plurality of drain through holes (37), which are elongated in the left-right direction, are formed in the connection wall (28) of the first member (21) at predetermined intervals in the left-right direction. Further, a plurality of fixation through holes (38) are formed in the connection wall (28) of the first member (21) at predetermined intervals in the left-right direction such that the fixation through holes (38) are located at positions shifted from the positions of the drain through holes (37). In the present embodiment, the drain through holes (37) and the fixation through holes (38) are formed alternately.

The second member (22) includes a first header-forming portion (41) which bulges upward and forms an upper portion of the refrigerant inlet header section (5); a second header-forming portion (42) which bulges upward and forms an upper portion of the refrigerant outlet header section (6); and a connection wall (43) which connects a rear edge portion of the first header-forming portion (41) and a front edge portion of the second header-forming portion (42), is brazed to the connection wall (28) of the first member (21), and forms an upper portion of the connection portion (7). The first header-forming portion (41) and the second header-forming portion (42) have a generally U-shaped transversal cross section; i.e., they are opened downward, and their central portions in the front-rear direction project upward. The first header-forming portion (41) includes front and rear walls (41a), and a top wall (41b) which integrally connects the upper end portions of the front and rear walls (41a), projects upward, and has an arcuate transverse cross section. Similarly, the second header-forming portion (42) includes front and rear walls (42a), and a top wall (42b) which connects the upper end portions of the front and rear walls (42a), projects upward, and has an arcuate transverse cross section.

Two pipe-holding portions (39) (arcuate pipe-holding portions) which extend in the left-right direction and have a generally semi-circular transverse section are integrally formed on the outer surface of the top wall (42b) of the second header-forming portion (42) of the second member (22) such that the pipe-holding portions (39) are separated from each other in the front-rear direction and extend over the entire length of the second member (22). Left end portions of the two pipe-holding portions (39) are removed over a predetermined length. Two straight portions (40a) of a hairpin-shaped refrigerant flow pipe (40) having a generally circular transverse cross section are fitted into the pipe-holding portions (39) and are brazed thereto. Thus, the refrigerant flow section (10), through which refrigerant fed from a condenser and not yet having passed through an expansion valve (a pressure-reducing device) flows, is provided on the refrigerant outlet header section (6). A bent portion of the refrigerant flow pipe (40) does not project leftward from the refrigerant outlet header section (6). Further, the pipe-holding portions (39) are in contact with the outer circumferential surface of the refrigerant flow pipe (40). Although not illustrated in the drawings, a tube extending from the condenser is connected to one end portion of the refrigerant flow pipe (40), and a tube extending to the expansion valve is connected to the other end portion of the refrigerant flow pipe (40). Notably, the other end portion of the refrigerant flow pipe (40) may be extended for direct connection to the expansion valve. In the illustrated example, the two pipe-holding portions (39) are formed on the outer surface of the top wall (42b) of the second header-forming portion (42). However, the present invention is not limited thereto, and the two pipe-holding portions (39) may be formed on the outer surface of one of the front and rear walls (42a). Alternatively, the pipe-holding portions (39) may be formed such that one pipe-holding portion (39) is provided on the outer surface of the top wall (42a) and the other holding portion (39) is provided on the outer surface of the front or rear wall (42a). That is, the pipe-holding portions (39) may be formed at any locations so long as the refrigerant flow pipe (40) held in the pipe-holding portions (39) does not interfere with the left-hand and right-hand end members (23) and (24) and the joint plate (25). Further, a plurality of inner fins (50) extending in the left-right direction are integrally formed on the inner surface of the top wall (42b) of the second header-forming portion (42) such that the inner fins (50) extend over the entire length of the second member (22).

A stopper portion (44) is integrally formed on the inner surface of a lower end portion of the front wall (41a) of the first header-forming portion (41) of the second member (22) over the entire length such that the stopper portion (44) projects downward, and the upper end of a front edge portion of each heat exchange tube (15) of the front heat exchange tube group (16) abuts against the stopper portion (44). A stopper portion (45) is integrally formed on the inner surface of a lower end portion of the rear wall (42a) of the second header-forming portion (42) over the entire length such that the stopper portion (45) projects downward, and the upper end of a rear edge portion of each heat exchange tube (15) of the rear heat exchange tube group (16) abuts against the stopper portion (45). A lower end portion of the rear wall (41a) and the stopper portion (44) of the first header-forming portion (41) of the second member (22) are connected together by means of a horizontal first divided-flow control wall (41c), which divides the interior of the refrigerant inlet header section (5) into upper and lower spaces (5a) and (5b). A stopper portion (46) is integrally formed on a rear edge portion of the lower surface of the first divided-flow control wall (41c) over the entire length such that the stopper portion (46) projects downward, and the upper end of a rear edge portion of each heat exchange tube (15) of the front heat exchange tube group (16) abuts against the stopper portion (46). A lower end portion of the front wall (42a) and the stopper portion (45) of the second header-forming portion (42) of the second member (22) are connected together, at the same height as the first divided-flow control wall (41c), by means of a horizontal second divided-flow control wall (42c), which divides the interior of the refrigerant outlet header section (6) into upper and lower spaces (6a) and (6b). A stopper portion (47) is integrally formed on a front edge portion of the lower surface of the second divided-flow control wall (42c) over the entire length such that the stopper portion (47) projects downward, and the upper end of a front edge portion of each heat exchange tube (15) of the rear heat exchange tube group (16) abuts against the stopper portion (47). The respective lower surfaces of the four stopper portions (44), (45), (46), and (47) of the second member (22) are located at the same vertical position.

The first divided-flow control wall (41c) of the second member (22) has a cutaway (48) extending from the left end thereof. Further, a divided-flow control hole (49), which is a through hole, is formed in the first divided-flow control wall (41c) at a location near the cutaway (48) and at a location near the right end of the first divided-flow control wall (41c). A plurality of oval refrigerant passage holes (51A) and (51B), which are through holes elongated in the left-right direction, are formed in a rear portion of the second divided-flow control wall (42b) of the second member (22) at predetermined intervals in the left-right direction, except for left and right end portions of the rear portion. The oval refrigerant passage hole (51A) at the center is shorter than the remaining oval refrigerant passage holes (51B), and is located between adjacent heat exchange tubes (15).

Drain through holes (52) elongated in the left-right direction are formed in the connection wall (43) of the second member (22) at positions corresponding to the drain through holes (37) of the first member (21). Further, a plurality of projections (53) are formed on the lower surface of the connection wall (43) at positions corresponding to fixation through holes (38) of the first member (21), and fitted into the fixation through holes (38). The first member (21) and the second member (22) are brazed as follows. In a state where the projections (53) are inserted into the fixation through holes (38) and crimped so as to provisionally fix the first member (21) and the second member (22) together, by making use of the brazing material layer of the first member (21), the front wall (31) of the first header-forming portion (26) of the first member (21) and the front wall (41a) of the first header-forming portion (41) of the second member (22) are brazed together. Similarly, the rear wall (34) of the second header-forming portion (27) of the first member (21) and the rear wall (42a) of the second header-forming portion (42) of the second member (22) are brazed together, and the connection wall (28) of the first member (21) and the connection wall (43) of the second member (22) are brazed together.

The first header-forming portion (26) of the first member (21) and the first header-forming portion (41) of the second member (22) form a hollow inlet-header-section main body (54), which is opened at opposite ends thereof. The second header-forming portion (27) of the first member (21) and the second header-forming portion (42) of the second member (22) form a hollow outlet-header-section main body (55), which is opened at opposite ends thereof.

The left end member (23) includes a front cap (23a) for closing the left end opening of the inlet-header-section main body (54), and a rear cap (23b) for closing the left end opening of the outlet-header-section main body (55). The front cap (23a) and the rear cap (23b) are integrated together via a connection portion (23c). The front cap (23a) of the left end member (23) includes an integrally formed, rightward projecting portion (56), which is fitted into the interior of the inlet-header-section main body (54). Similarly, the rear cap (23b) includes an upper rightward projecting portion (57) and a lower rightward projecting portion (58) integrally formed such that they are separated from each other in the vertical direction. The upper rightward projecting portion (57) is fitted into the space (6a) of the outlet-header-section main body (55) located above the second divided-flow control wall (42b). The lower rightward projecting portion (58) is fitted into the space (6b) of the outlet-header-section main body (55) located below the second divided-flow control wall (42b). Engagement fingers (59) projecting rightward for engagement with the first and second members (21) and (22) are formed integrally with the left end member (23) at connection portions between the front and rear side edges and the upper and lower edges. The left end member (23) is brazed to the two members (21) and (22) by making use of the brazing material layer of itself. The left end opening of the cutaway (48) of the first divided-flow control wall (41c) is closed by the front cap (23a) of the left end member (23), whereby a communication hole (61) is formed for establishing communication between the upper and lower spaces (5a) and (5b) of the inlet header section (5) at the left end thereof. Notably, in the present embodiment, the communication hole (61) is formed by closing the left end opening of the cutaway (48) by the front cap (23a) of the left end member (23). However, instead of forming the cutaway, a through hole may be formed in a left end portion of the first divided-flow control wall (41c) as a communication hole.

The right end member (24) includes a front cap (24a) for closing the right end opening of the inlet-header-section main body (54), and a rear cap (24b) for closing the right end opening of the outlet-header-section main body (55). The front cap (24a) and the rear cap (24b) are integrated together via a connection portion (24c). The front cap (24a) of the right end member (24) includes an upper leftward projecting portion (62) and a lower leftward projecting portion (63) integrally formed such that they are separated from each other in the vertical direction. The upper leftward projecting portion (62) is fitted into the space (5a) of the inlet-header-section main body (54) located above the first divided-flow control wall (41c). The lower leftward projecting portion (63) is fitted into the space (5b) of the inlet-header-section main body (54) located below the first divided-flow control wall (41c). Similarly, the rear cap (24b) includes an upper leftward projecting portion (64) and a lower leftward projecting portion (65) integrally formed such that they are separated from each other in the vertical direction. The upper leftward projecting portion (64) is fitted into the space (6a) of the outlet-header-section main body (55) located above the second divided-flow control wall (42b). The lower leftward projecting portion (65) is fitted into the space (6b) of the outlet-header-section main body (55) located below the second divided-flow control wall (42b). A refrigerant inlet (66) is formed in a projecting end wall of the upper leftward projecting portion (62) of the front cap (24a) of the right end member (24). Similarly, a refrigerant outlet (67) is formed in a projecting end wall of the upper leftward projecting portion (64) of the rear cap (24b) of the right end member (24). Engagement fingers (68) projecting leftward for engagement with the first and second members (21) and (22) are formed integrally with the right end member (24) at connection portions between the front and rear side edges and the upper edge of the right end member (24), as well as at a front portion of the lower edge of the front cap (24a) and a rear portion of the lower edge of the rear cap (24b).

Also, a first engagement male portion (71) is formed integrally with the connection portion (24c) of the right end member (24) such that the first engagement male portion (71) projects upward from a central portion of the upper end of the connection portion (24c) with respect to the front-rear direction. Similarly, a second engagement male portion (72) is formed integrally with the connection portion (24c) of the right end member (24) such that the second engagement male portion (72) projects downward from a central portion of the lower end of the connection portion (24c) with respect to the front-rear direction. In a state before the right end member (24) is assembled to the joint plate (25) during the manufacture of the evaporator (1), the second engagement male portion (72) projects rightward. Further, cutouts (80) are formed in front and rear end portions of a lower edge portion of the right end member (24). The right end member (24) is brazed to the members (21) and (22) by making use of the brazing material layer of itself.

The joint plate (25) includes a short, cylindrical refrigerant inflow port (73) communicating with the refrigerant inlet (66) of the right end member (24), and a short, cylindrical refrigerant outflow port (74) communicating with the refrigerant outlet (67) of the right end member (24). The refrigerant inflow port (73) and the refrigerant outflow port (74) are each composed of a circular through hole and a short cylindrical tubular portion formed integrally with the joint plate (25) such that the short cylindrical tubular portion surrounds the through hole and projects rightward.

The joint plate (25) has a vertically extending slit for short prevention (75) formed between the refrigerant inflow port (73) and the refrigerant outflow port (74), and generally trapezoidal through holes (76) and (77) communicating with the upper and lower ends of the slit (75), respectively. Portions of the joint plate (25) located above the upper through hole (76) and below the lower through hole (77) are bent in a U-like shape so as to project leftward to thereby form first and second engagement female portions (78) and (79). The first engagement male portion (71) of the right end member (24) is inserted into the first engagement female portion (78) from the lower side thereof for engagement with the first engagement female portion (78). The second engagement male portion (72) of the right end member (24) is inserted into the second engagement female portion (79) from the upper side thereof for engagement with the second engagement female portion (79). Thus, movement of the joint plate (25) in the left-right direction is prevented. The second engagement male portion (72) of the right end member (24) in a state in which it projects rightward is passed through the lower through hole (77), and then bent downward, whereby the second engagement male portion (72) is inserted into the second engagement female portion (79) from the upper side thereof. The first engagement female portion (78) is in engagement with front and rear side portions of the first engagement male portion (71) of the connection portion (24c) of the right end member (24), whereby downward movement of the joint plate (25) is prevented. Moreover, engagement fingers (81) projecting leftward are formed integrally with the joint plate (25) at front and rear end portions of the lower edge thereof. The joint plate (25) is engaged with the right end member (24) with the engagement fingers (81) fitted into the cutouts (80) formed along the lower edge of the right end member (24). Thus, upward, frontward, and rearward movements of the joint plate (25) are prevented. The joint plate (25) is brazed to the right end member (24) by making use of the brazing material layer of the right end member (24) in a state in which the joint plate (25) is engaged with the right end member (24) such that leftward and rightward movements, upward and downward movements, and frontward and rearward movements of the joint plate (25) are prevented as described above.

A diameter-reduced portion of the refrigerant inlet pipe (8) formed at one end thereof is inserted into and brazed to the refrigerant inflow port (73) of the joint plate (25). Similarly, a diameter-reduced portion of the refrigerant outlet pipe (9) formed at one end thereof is inserted into and brazed to the refrigerant inflow port (74) of the joint plate (25). Although not illustrated in the drawings, an expansion valve attachment member is joined to the opposite end portions of the refrigerant inlet pipe (8) and the refrigerant outlet pipe (9) such that the expansion valve attachment member extends over the two pipes (8) and (9), and an expansion valve is attached to the expansion valve attachment member.

As shown in FIGS. 2, 3, 6, and 7, the refrigerant turn header tank (3) is composed of a plate-like first member (82), a second member (83), left and right aluminum end members (84) and (85), and a communication member (86). The first member (82) is formed of an aluminum brazing sheet having a brazing material layer over opposite surfaces thereof. All the heat exchange tubes (15) are connected to the first member (82). The second member (83) is formed from a bare aluminum extrudate, and covers the lower side of the first member (82). The aluminum end members (84) and (85) are formed of an aluminum brazing sheet having a brazing material layer over opposite surfaces thereof, and are brazed to the left and right ends of the first member (82) and the second member (83). The communication member (86) is formed of an aluminum brazing sheet having a brazing material layer over opposite surfaces thereof, and is brazed to an outer surface of the right end member (85) such that the communication member (86) extends over the first intermediate header section (11) and the second intermediate header section (12). The first intermediate header section (11) and the second intermediate header section (12) communicate with each other at their right ends via the communication member (86).

The first member (82) has the same shape as the first member (21) of the refrigerant inlet/outlet header tank (2), and is a mirror image of the first member (21) with respect to the vertical direction. In the first member (82) of the refrigerant turn header tank (3), portions identical with those of the first member (21) of the refrigerant inlet/outlet header tank (2) are denoted by like reference numerals, and their descriptions will not be repeated. A first header-forming portion (26) forms an upper portion of the first intermediate header section (11); and a second header-forming portion (27) forms an upper portion of the second intermediate header section (12). The rear wall (32) of the first header-forming portion (26) of the first member (82), the front wall (35) of the second header-forming portion (27) of the first member (82), and the connection wall (28) of the first member (82) form a drain trough (14), whose opposite side surfaces extend upward while inclining toward the outer side with respect to the front-rear direction.

The second member (83) is a mirror image of the second member (22) of the refrigerant inlet/outlet header tank (2) with respect to the vertical direction, and is formed of the same aluminum extrudate as that of the second member (22), except that the pipe-holding portions (39) are completely removed, the first divided-flow control wall (41c) is completely removed, and, in place of the oval refrigeration passage holes (51A) and (51B), a plurality of circular refrigeration passage holes (87) are formed in a rear portion of the second divided-flow control wall (42c) at predetermined intervals in the left-right direction such that the passage holes extend through the rear portion. Notably, the distance between adjacent circular refrigeration passage holes (87) formed in the second divided-flow control wall (42c) gradually increases with the distance from the right end thereof. The distance between adjacent circular refrigeration passage holes (87) may be made constant among all the circular refrigeration passage holes (87). In the second member (83) of the refrigerant turn header tank (3), portions identical with those of the second member (22) of the refrigerant inlet/outlet header tank (2) are denoted by like reference numerals, and their descriptions will not be repeated. The second divided-flow control wall (42b) divides the interior of the second intermediate header section (12) into upper and lower spaces (12a) and (12b).

The first member (82) and the second member (83) are brazed together in a manner similar to that for the first member (21) and the second member (22) of the refrigerant inlet/outlet header tank (2). Lower end portions of the heat exchange tubes (15) of the front and rear heat exchange tube groups (16) of the heat exchange core section (4) are inserted into tube insertion holes (36) of the first member (82) such that the lower ends of the front and rear edge portions of the heat exchange tubes (15) of the front heat exchange tube group (16) come into contact with the stopper portion (44) of the front wall (41a) of the first header-forming portion (41) and the stopper portion (46) of the first divided-flow control wall (41c), respectively, and the lower ends of the front and rear edge portions of the heat exchange tubes (15) of the rear heat exchange tube group (16) come into contact with the stopper portion (45) of the rear wall (42a) of the second header-forming portion (42) and the stopper portion (47) of the second divided-flow control wall (42c), respectively. In this state, the lower end portions of the heat exchange tubes (15) are brazed to the first member (82) by making use of the brazing material layer of the first member (82). Thus, the lower end portions of the heat exchange tubes (15) of the front heat exchange tube group (16) are connected to the first intermediate header section (11) such that fluid communication is established therebetween; and the lower end portions of the heat exchange tubes (15) of the rear heat exchange tube group (16) are connected to the second intermediate header section (12) such that fluid communication is established therebetween.

The first header-forming portion (26) of the first member (82) and the first header-forming portion (41) of the second member (83) form a hollow first-intermediate-header-section main body (88), which is opened at opposite ends thereof. The second header-forming portion (27) of the first member (82) and the second header-forming portion (42) of the second member (83) form a hollow second-intermediate-header-section main body (89), which is opened at opposite ends thereof.

The left end member (84) includes a front cap (84a) for closing the left end opening of the first-intermediate-header-section main body (88), and a rear cap (84b) for closing the left end opening of the second-intermediate-header-section main body (89). The front cap (84a) and the rear cap (84b) are integrated together via a connection portion (84c). The front cap (84a) includes an integrally formed, rightward projecting portion (91), which is fitted into the interior of the first-intermediate-header-section main body (88). Similarly, the rear cap (84b) includes an upper rightward projecting portion (92) and a lower rightward projecting portion (93) integrally formed such that they are separated from each other in the vertical direction. The upper rightward projecting portion (92) is fitted into the space (12a) of the second-intermediate-header-section main body (89) located above the second divided-flow control wall (42c). The lower rightward projecting portion (93) is fitted into the space (12b) of the second-intermediate-header-section main body (89) located below the second divided-flow control wall (42c). Engagement fingers (94) projecting rightward for engagement with the first and second members (82) and (83) are formed integrally with the left end member (84) at connection portions between the front and rear side edges and the upper and lower edges. The left end member (84) is brazed to the two members (82) and (83) by making use of the brazing material layer of itself.

The right end member (85) includes a front cap (85a) for closing the right end opening of the first-intermediate-header-section main body (88), and a rear cap (85b) for closing the right end opening of the second-intermediate-header-section main body (89). The front cap (85a) and the rear cap (85b) are integrated together via a connection portion (85c). The front cap (85a) includes an integrally formed, leftward projecting portion (95), which is fitted into the interior of the first-intermediate-header-section main body (88). Similarly, the rear cap (85b) includes an upper leftward projecting portion (96) and a lower rightward projecting portion (97) integrally formed such that they are separated from each other in the vertical direction. The upper leftward projecting portion (96) is fitted into the space (12a) of the second-intermediate-header-section main body (89) located above the second divided-flow control wall (42c). The lower leftward projecting portion (97) is fitted into the space (12b) of the second-intermediate-header-section main body (89) located below the second divided-flow control wall (42c). Engagement fingers (101) projecting leftward for engagement with the first and second members (82) and (83) are formed integrally with the right end member (85) at connection portions between the front and rear side edges and the upper and lower edges. Further, the right end member (85) has integrally formed engagement fingers (102) which project rightward from front and rear end portions of the upper edge of the right end member (85). The engagement fingers (102) are bent downward for engagement with an upper edge portion of the communication member (86). The right end member (85) also has an integrally formed engagement finger (102) which projects rightward from a central portion of the lower edge of the right end member (85) with respect to the front-rear direction. The engagement finger (102) is bent upward for engagement with a lower edge portion of the communication member (86).

A refrigerant outflow opening (104) is formed in a projecting end wall of the leftward projecting portion (95) of the front cap (85a) of the right end member (85) so as to allow refrigerant to flow out of the interior of the first intermediate header section (11). Similarly, a refrigerant inflow opening (105) is formed in a projecting end wall of the lower leftward projecting portion (97) of the rear cap (85b) of the right end member (85) so as to allow refrigerant to flow into the space (12b) of the second intermediate header section (12) located below the second divided-flow control wall (42c). Further, a guide portion (106), which is upwardly inclined or curbed (in the present embodiment, curved) toward the interior of the second intermediate header section (12), is integrally formed at a lower portion of the circumferential edge of the refrigerant inflow opening (105) of the lower leftward projecting portion (97) of the rear cap (85b). The right end member (85) is brazed to the first and second members (82) and (83) by making use of the brazing material layer of itself.

The communication member (86) is formed from an aluminum bare material through press working, and assumes the form of a plate whose outer shape is identical in shape and size with the right end member (85) as viewed from the right. A circumferential edge portion of the communication member (86) is brazed to the outer surface of the right end member (85) by making use of the brazing material layer of the right end member (85). The communication member (86) has an outwardly bulging portion (108) for establishing communication between the refrigerant outflow opening (104) and the refrigerant inflow opening (105) of the right end member (85). The interior of the outwardly bulging portion (108) serves as a communication passage for establishing communication between the refrigerant outflow opening (104) and the refrigerant inflow opening (105) of the right end member (85).

In manufacture of the above-described evaporator (1), all the components thereof, excluding the inlet pipe (8) and the outlet pipe (9), are assembled together and provisionally fixed together; and all the components provisionally fixed together are subjected brazing simultaneously.

The evaporator (1), together with a compressor and a condenser (serving as a refrigerant cooler), constitutes a refrigeration cycle, which uses a chlorofluorocarbon-based refrigerant and is installed in a vehicle, for example, an automobile, as a car air conditioner.

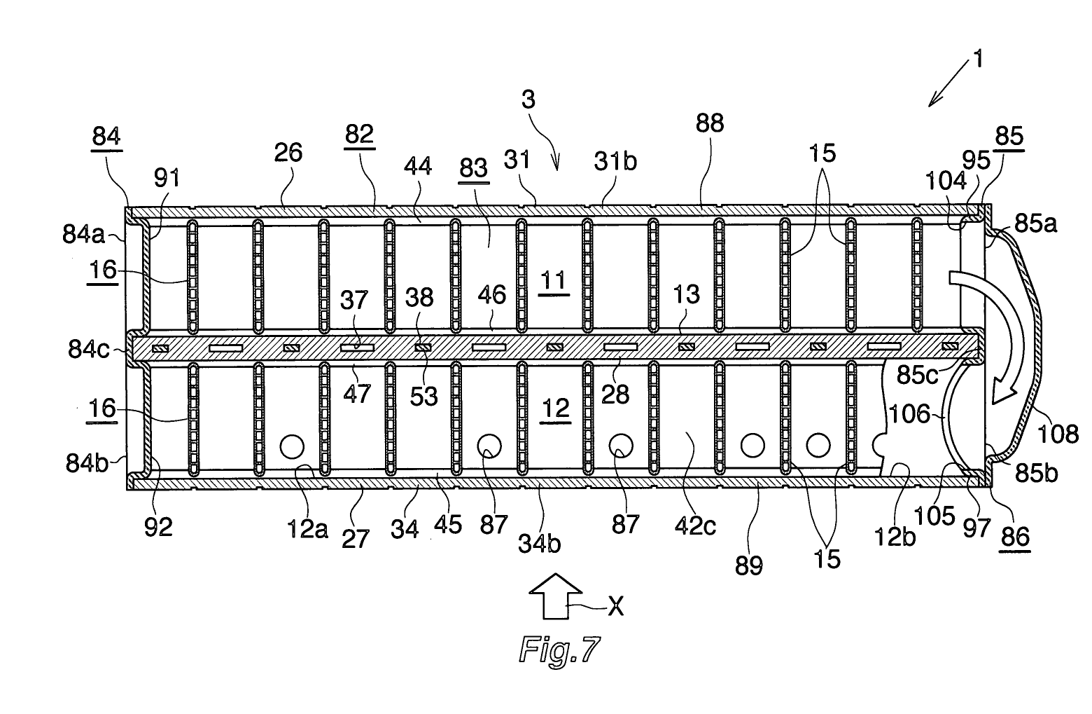

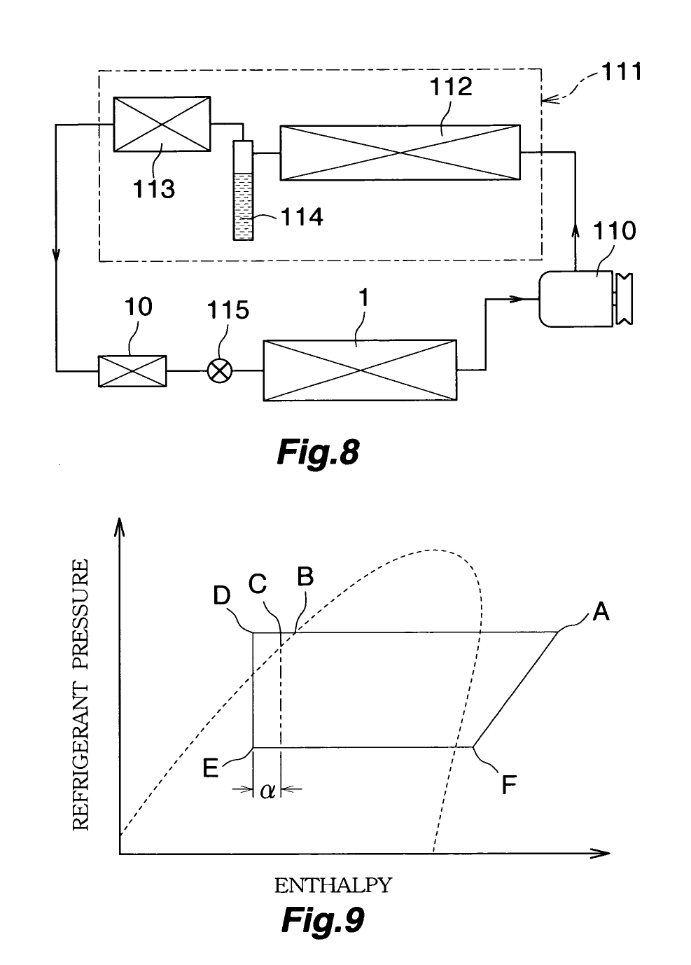

Next, operation of the refrigeration cycle including the above-described evaporator (1) will be described with reference to FIGS. 8 and 9.

Gas-liquid two-phase refrigerant having been compressed by a compressor (110) and having a high temperature and a high pressure (see State A in FIG. 9) is cooled at a condensation section (112) of a condenser (111) (see State B in FIG. 9), and, after passing through a liquid receiver (114), is super-cooled at a supercooling section (113) (see State C in FIG. 9). The super-cooled refrigerant flows into the refrigerant flow pipe (40), which constitutes the refrigerant flow section (10) of the evaporator (1). While flowing through the refrigerant flow pipe (40), the refrigerant is further cooled by refrigerant which flows through the upper space (6a) of the refrigerant outlet header section (6) of the evaporator (1) and which has a relatively low temperature (see State D in FIG. 9). Accordingly, the refrigerant before entering the expansion valve is super-cooled by an amount indicated by α in FIG. 9, as compared with a refrigeration cycle including a conventional evaporator. The refrigerant having passed through the refrigerant flow pipe (40) is adiabatically expanded at the expansion valve (115), so that the pressure of the refrigerant is lowered (see State E in FIG. 9).

The gas-liquid two-phase refrigerant having a lowered pressure enters the upper space (5a) of the refrigerant inlet header section (5) of the refrigerant inlet/outlet header tank (2) from the refrigerant inlet pipe (8) through the refrigerant inflow port (73) of the joint plate (25) and the refrigerant inlet (66) of the front cap (24a) of the right end member (24). Then, the refrigerant having entered the upper space (5a) of the refrigerant inlet header section (5) flows leftward and subsequently flows into the lower space (5b) via the communication hole (61), as well as the divided-flow control hole (49) of the first divided-flow control wall (41c).

The refrigerant having entered the lower space (5b) dividedly flows into the refrigerant channels of the heat exchange tubes (15) of the front heat exchange tube group (16). The refrigerant having entered the refrigerant channels of the heat exchange tubes (15) flows downward through the refrigerant channels and enters the interior of the first intermediate header section (11) of the refrigerant turn header tank (3). The refrigerant having entered the interior of the first intermediate header section (11) flows rightward within the first intermediate header section (11). The refrigerant then flows through the refrigerant outflow opening (104) of the front cap-(85a) of the right end member (85), the communication passage within the outward bulging portion (108) of the communication member (86), and the refrigerant inflow opening (105) of the rear cap (85b), thereby changing its flow direction to make a turn and entering the lower space (12b) of the second intermediate header section (12).

The refrigerant having entered the lower space (12b) of the second intermediate header section (12) flows leftward; enters the upper space (12a) via the circular refrigeration passage holes (87) formed in the second divided-flow control wall (42c); and dividedly flows into the refrigerant channels of the heat exchange tubes (15) of the rear heat exchange tube group (16). The refrigerant having flowed into the refrigerant channels of the heat exchange tubes (15) flows upward within the refrigerant channels, while changing its flow direction; and enters the lower space (6b) of the refrigerant outlet header section (6). While the refrigerant flows through the refrigerant channels of the heat exchange tubes (15) of the front heat exchange tube group (16) and the refrigerant channels of the heat exchange tubes (15) of the rear heat exchange tube group (16), the refrigerant performs heat exchange with air flowing through the air-passing clearances in the direction represented by arrow X in FIG. 1, and assumes the gas phase.

Subsequently, the refrigerant enters the upper space (6a) through the refrigerant passage holes (51A) and (51B) of the second divided-flow control wall (42c). In the upper space (6a), the refrigerant cools the gas-liquid two-phase refrigerant which flows through the refrigerant flow pipe (40) and which is relatively high in temperature. Subsequently, the refrigerant flows out to the refrigerant outlet pipe (9) through the refrigerant outlet (67) of the rear cap (24b) of the right end member (24) and the refrigerant outflow port (74) of the joint plate (25). The refrigerant is then fed to the compressor (110) (see State F in FIG. 9).

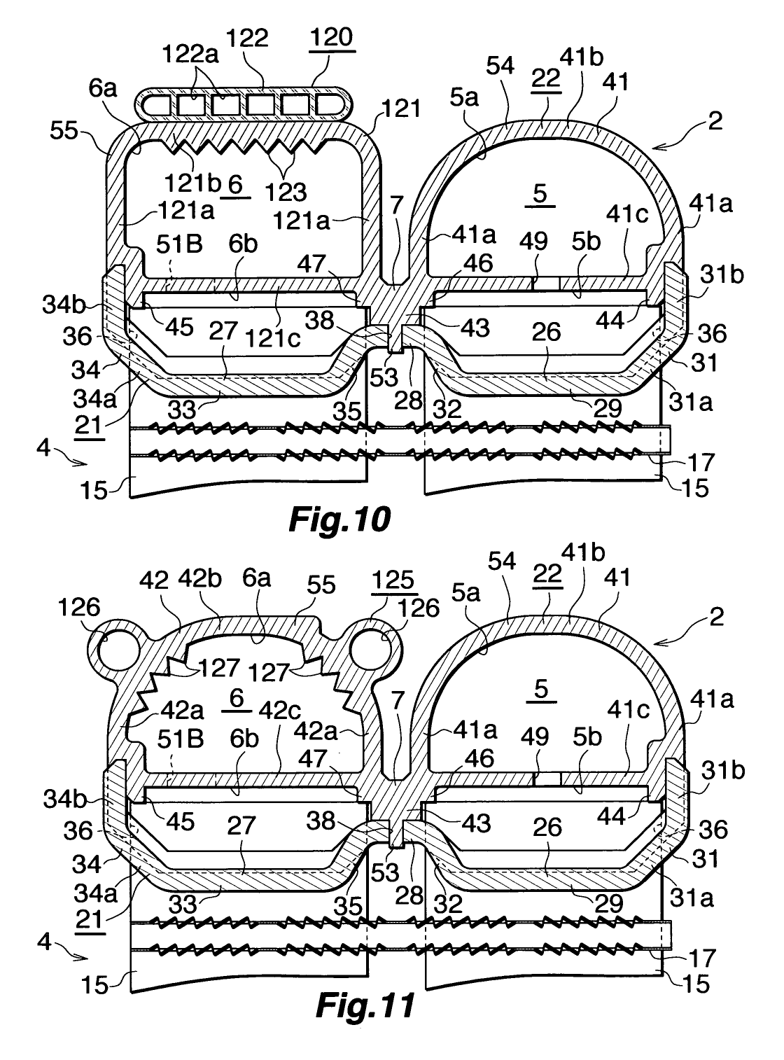

FIGS. 10 to 13 show modifications of the refrigerant flow section provided on the refrigerant outlet header section (6).

In FIG. 10, a refrigerant flow section (120) through which the refrigerant fed from the condenser and not yet having passed through the expansion valve flows is composed of a flat refrigerant flow pipe (122) which is formed of an aluminum extrudate and which is brazed to the outer surface of the refrigerant outlet header section (6).

The second header-forming portion (121) of the second member (22), which constitutes the refrigerant outlet header section (6), has a generally U-shaped transverse cross section; i.e., is opened downward, and includes front and rear walls (121a) and a horizontal flat top wall (121b), which integrally connects upper end portions of the front and rear walls (121a). The outer surface of the top wall (121b) serves a flat surface extending in the longitudinal direction of the refrigerant outlet header section (6). A lower end portion of the front wall (121a) and the stopper portion (45) of the second header-forming portion (121) of the second member (22) are connected together by means of a horizontal second divided-flow control wall (121c), which divides the interior of the refrigerant outlet header section (6) into upper and lower spaces (6a) and (6b).

The refrigerant flow pipe (122) extends in the left-right direction such that its width direction coincides with the front-rear direction, and is brazed to the outer surface of the top wall (121b) of the second header-forming portion (121). The refrigerant flow pipe (122) includes a plurality of refrigerant channels (122a) formed therein such that the refrigerant channels (122a) extend in the left-right direction and are arranged in the front-rear direction. The tube extending from the condenser is connected to one end portion of the refrigerant flow pipe (122), and the tube extending to the expansion valve is connected to the other end portion of the refrigerant flow pipe (122). Further, a plurality of inner fins (123) extending in the left-right direction are integrally formed on the inner surface of the top wall (121b) of the second header-forming portion (121) over the entire length of the second member (22).

In FIG. 11, a refrigerant flow section (125) through which the refrigerant fed from the condenser and not yet having passed through the expansion valve flows is composed of two tubular portions (126) each having a generally circular transverse cross section. The tubular portions (126) are integrally formed on the outer surface of the top wall (42b) of the second header-forming portion (42) of the second member (22), which constitutes the refrigerant outlet header section (6), such that the tubular portions (126) are separated from each other in the front-rear direction and extend over the entire length of the second member (22). The two tubular portions (126) are connected with each other at their first end portions by unillustrated proper means. The tube extending from the condenser is connected to the second end portion of one tubular portion (126), and the tube extending to the expansion valve is connected to the second end portion of the other tubular portion (126). In the illustrated example, the two tubular portions (126) are formed on the outer surface of the top wall (42b) of the second header-forming portion (42). However, the present invention is not limited thereto, and the two tubular portions (126) may be formed on the outer surfaces of the front and rear walls (42a). Alternatively, the two tubular portions (126) may be formed such that one tubular portion (126) is provided on the outer surface of the front or rear wall (42a) and the other tubular portion (126) is provided on the outer surface of the top wall (42b), respectively. Further, a plurality of inner fins (127) extending in the left-right direction are integrally formed on the inner surface of the top wall (42b) of the second header-forming portion (42) in regions corresponding to the two tubular portions (126) such that the inner fins (127) extend over the entire length of the second member (22).

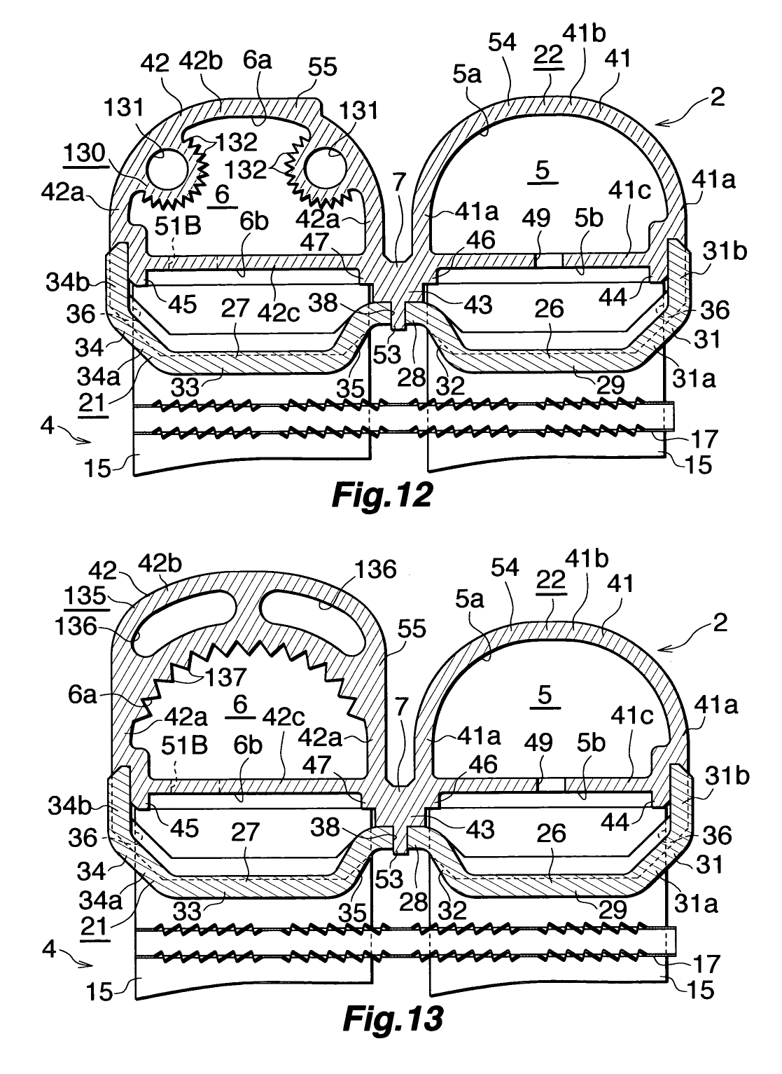

In FIG. 12, a refrigerant flow section (130) through which the refrigerant fed from the condenser and not yet having passed through the expansion valve flows is composed of two tubular portions (131) each having a generally circular transverse cross section. The tubular portions (131) are integrally formed on the inner surface of the top wall (42b) of the second header-forming portion (42) of the second member (22), which constitutes the refrigerant outlet header section (6), such that the tubular portions (131) are separated from each other in the front-rear direction and extend over the entire length of the second member (22). The two tubular portions (131) are connected with each other at their first end portions by unillustrated proper means. The tube extending from the condenser is connected to the second end portion of one tubular portion (131), and the tube extending to the expansion valve is connected to the second end portion of the other tubular portion (131). In the illustrated example, the two tubular portions (131) are formed on the inner surface of the top wall (42b) of the second header-forming portion (42). However, the present invention is not limited thereto, and the two tubular portions (131) may be formed on the inner surfaces of the front and rear walls (42a). Alternatively, the two tubular portions (131) may be formed such that one tubular portion (131) is provided on the inner surface of the front or rear wall (42a) and the other tubular portion (131) is provided on the inner surface of the top wall (42b), respectively. Further, a plurality of inner fins (132) extending in the left-right direction are integrally formed on the outer surfaces of the two tubular portions (131) such that the inner fins (132) face the interior of the second header-forming portion (42) and extend over the entire length of the second member (22).

In FIG. 13, a refrigerant flow section (135) through which the refrigerant fed from the condenser and not yet having passed through the expansion valve flows is composed of the top wall (42b) of the second header-forming portion (42) of the second member (22), which constitutes the refrigerant outlet header section (6). Specifically, the top wall (42b) of the second header-forming portion (42) of the second member (22), which constitutes the refrigerant outlet header section (6), has an increased wall thickness, and refrigerant passageways (136) extending in the left-right direction are formed in the top wall (42b) such that the refrigerant passageways (136) are separated from each other in the front-rear direction and extend over the entire length of the second member (22). Thus, the top wall (42b) including the refrigerant passageways (136) formed therein serves as the refrigerant flow section (135), through which the refrigerant fed from the condenser and not yet having passed through the expansion valve flows. The two refrigerant passageways (136) are connected with each other at their first end portions by unillustrated proper means. The tube extending from the condenser is connected to the second end portion of one refrigerant passageway (136), and the tube extending to the expansion valve is connected to the second end portion of the other refrigerant passageway (136). A plurality of inner fins (137) extending in the left-right direction are integrally formed on the inner surface of the top wall (42b) of the second header-forming portion (42) such that the inner fins (137) extend over the entire length of the second member (22).

In the above-described embodiment, one heat exchange tube group (16) is provided between the refrigerant inlet header section (5) of the header tank (2) and the first intermediate header section (11) of the header tank (3) and another heat exchange tube group (16) is provided between the refrigerant outlet header section (6) of the header tank (2) and the second intermediate header section (12) of the header tank (3). The arrangement of the heat exchange tube groups is not limited thereto. Two or more heat exchange tube groups (16) may be provided between the refrigerant inlet header section (5) of the header tank (2) and the first intermediate header section (11) of the header tank (3) and between the refrigerant outlet header section (6) of the header tank (2) and the second intermediate header section (12) of the header tank (3). Further, the above-described embodiment may be modified such that the refrigerant inlet/outlet header tank is located below the refrigerant turn header tank.

Further, in the above-described embodiment, the heat exchange core section (4) includes a plurality of (specifically, two) heat exchange tube groups (16). However, the embodiment may be modified such that the heat exchange core section (4) includes a single heat exchange tube group (16). In this case, the refrigerant inlet header section and the refrigerant outlet header section may be disposed such that the refrigerant inlet header section is located on the upper or lower side of the exchange core section (4) and the refrigerant outlet header section is located on the side opposite the refrigerant inlet header section, or such that the refrigerant inlet header section and the refrigerant outlet header section are located on the upper or lower side of the exchange core section (4) and arranged side by side in the left-right direction.

What is claimed is:

1. An evaporator comprising a refrigerant inlet header section extending in a left-right direction, a refrigerant outlet header section extending in the left-right direction, and a refrigerant passageway which establishes communication between the refrigerant inlet header section and the refrigerant outlet header section, wherein a refrigerant inlet is formed in the refrigerant inlet header section; a refrigerant outlet is formed in the refrigerant outlet header section; and refrigerant having flowed into the interior of the refrigerant inlet header section from the refrigerant inlet flows into the interior of the refrigerant outlet header section via the refrigerant passageway and is fed out from the refrigerant outlet, wherein
a refrigerant flow section is provided on the refrigerant outlet header section so as to allow refrigerant fed from a condenser and not yet having passed through a pressure-reducing device to flow through the refrigerant flow section, such that heat exchange is effected between the refrigerant within the refrigerant outlet header section and the refrigerant flowing through the refrigerant flow section.

2. An evaporator according to claim 1, wherein the refrigerant flow section is composed of a refrigerant flow pipe which is mechanically or metallurgically joined to a wall surface of the refrigerant outlet header section.

3. An evaporator according to claim 2, wherein a pipe-holding portion is provided on the wall surface of the refrigerant outlet header section, and the refrigerant flow pipe is held by the pipe-holding portion.

4. An evaporator according to claim 3, wherein the refrigerant flow pipe has a generally circular transverse cross section, and the pipe-holding portion is shaped such that the pipe-holding portion comes into contact with an outer circumferential surface of the refrigerant flow pipe.

5. An evaporator according to claim 4, wherein the refrigerant outlet header section is formed of a plurality of members, at least one of the members is formed of an extrudate, and the pipe-holding portion is integrally formed on the member formed of an extrudate.

6. An evaporator according to claim 2, wherein the refrigerant outlet header section has a flat surface formed on its outer surface and extending in a longitudinal direction of the refrigerant outlet header section, the refrigerant flow pipe assumes a flat shape and has a pair of flat walls, and an outer surface of one of the flat walls of the refrigerant flow pipe is in surface contact with the flat surface on the outer surface of the refrigerant outlet header section.

7. An evaporator according to claim 2, wherein the refrigerant outlet header section has an inner fin formed on its inner surface and extending in a longitudinal direction of the refrigerant outlet header section.

8. An evaporator according to claim 1, wherein the refrigerant outlet header section is formed of a plurality of members, at least one of the members is formed of an extrudate, and the member formed of an extrudate has an integrally formed hollow refrigerant flow section extending in a longitudinal direction of the member formed of an extrudate.

9. An evaporator according to claim 8, wherein the refrigerant flow section is formed on the outer side of the refrigerant outlet header section.

10. An evaporator according to claim 9, wherein the refrigerant outlet header section has an inner fin formed on its inner surface and extending in a longitudinal direction of the refrigerant outlet header section.

11. An evaporator according to claim 8, wherein the refrigerant flow section is formed on the inner side of the refrigerant outlet header section.

12. An evaporator according to claim 11, wherein the refrigerant flow section has an inner fin formed on its surface facing the interior of the refrigerant outlet header section such that the inner fin extends in a longitudinal direction of the refrigerant flow section.

13. An evaporator according to claim 1, wherein the refrigerant inlet header section and the refrigerant outlet header section are disposed side by side in a front-rear direction; and the refrigerant passageway includes a first intermediate header section extending in the left-right direction and separated from the refrigerant inlet header section, a second intermediate header section extending in the left-right direction, disposed on the rear side of the first intermediate header section to be separated from the refrigerant outlet header section, and communicating with the first intermediate header section, a plurality of heat exchange tubes disposed between the refrigerant inlet header section and the first intermediate header section and having opposite ends connected to the refrigerant inlet header section and the first intermediate header section, and a plurality of heat exchange tubes disposed between the refrigerant outlet header section and the second intermediate header section and having opposite ends connected to the refrigerant outlet header section and the second intermediate header section.

14. An evaporator according to claim 13, wherein the refrigerant inlet header section and the refrigerant outlet header section are integrated together to form a refrigerant inlet/outlet header tank, and the refrigerant inlet/outlet header tank includes a first member which is formed of aluminum and to which the heat exchange tubes are connected, and a second member which is joined to a side of the first member opposite the heat exchange tubes and which is formed of an aluminum extrudate.
